(19) United States
(12) Patent Application Publication
(10) Pub. No.: US 2014/0267152 A1
(43) Pub. Date: Sep. 18, 2014

(54) Force Sensing X-Y Touch Sensor

(71) Applicant: Mircrochip Technology Incorporated, Chandler, AZ (US)

(72) Inventor: Keith E. Curtis, Gilbert, AZ (US)

(21) Appl. No.: 14/097,370

(22) Filed: Dec. 5, 2013

Related U.S. Application Data
(60) Provisional application No. 61/777,910, filed on Mar. 12, 2013.

(51) Int. Cl. G06F 3/041

(52) U.S. Cl. CPC G06F 3/0414
USPC 345/174

(57) ABSTRACT

A force sensing X-Y touch sensor comprising a plurality of conductive electrode rows, a plurality of electrode columns substantially perpendicular to and over the plurality of conductive electrode rows, a flexible electrically conductive cover over the electrode columns and a plurality of deformable spacers between the cover and the electrode columns, wherein the deformable spacers maintains a distance between the cover and the electrode columns. When a touch is applied to the surface of X-Y touch sensor, the flexible cover is biased toward the electrode columns and rows and changes the capacitance value thereof at the location of the touch thereto. This change in capacitance value is proportional to the force of the touch on the surface of the flexible electrically conductive cover. Therefore the location of the touch and the force thereof may be determined by how much the capacitance value changes.

### RELATED PATENT APPLICATION

This application claims priority to commonly owned U.S. Provisional Patent Application Ser. No. 61/777,910 filed Mar. 12, 2013; which is hereby incorporated by reference herein for all purposes.

### TECHNICAL FIELD

The present disclosure relates to touch sensors, and, more particularly, to a touch sensor that senses both touch location(s) and pressure (force) applied at the touch location(s).

### BACKGROUND

Touch sensors generally can only determine a location of a touch thereto, but not a force value of the touch to the touch sensor face. Being able to determine not only the X-Y coordinate location of a touch but also the force of the touch gives another control option that may be used with a device having a touch sensor with such features.

### SUMMARY

Therefore, a need exists for a touch sensor that may be used to detect both a location(s) of a touch(es) thereto and a force(s) thereof.

According to an embodiment, an apparatus for determining a location of a touch thereto and a force thereof on a touch sensing surface may comprise: a first plurality of electrodes arranged in a parallel orientation having a first axis, wherein each of the first plurality of electrodes may comprise a self capacitance; a second plurality of electrodes arranged in a parallel orientation having a second axis substantially perpendicular to the first axis, the first plurality of electrodes may be located over the second plurality of electrodes and form a plurality of nodes comprising overlapping intersections of the first and second plurality of electrodes, wherein each of the plurality of nodes may comprise a mutual capacitance; a flexible electrically conductive cover over the first plurality of electrodes, wherein a face of the flexible electrically conductive cover may form the touch sensing surface; and a plurality of deformable spacers between the flexible electrically conductive cover and the first plurality of electrodes, wherein the plurality of deformable spacers may maintain a distance between the flexible electrically conductive cover and the first plurality of electrodes.

According to a further embodiment, the flexible electrically conductive cover may comprise a flexible metal substrate. According to a further embodiment, the flexible electrically conductive cover may comprise a flexible non-metal substrate and an electrically conductive coating on a surface thereof. According to a further embodiment, the flexible electrically conductive cover may comprise a substantially light transmissive flexible substrate and a coating of Indium Tin Oxide (ITO) on a surface of the flexible substrate. According to a further embodiment, the flexible electrically conductive cover may comprise a substantially light transmissive flexible substrate and a coating of Antimony Tin Oxide (ATO) on a surface of the flexible substrate.

According to another embodiment, a method for determining a location of a touch thereto and a force thereof on a touch sensing surface may comprise the steps of: providing a first plurality of electrodes arranged in a parallel orientation having a first axis, wherein each of the first plurality of electrodes may comprise a self capacitance; providing a second plurality of electrodes arranged in a parallel orientation having a second axis substantially perpendicular to the first axis, the first plurality of electrodes may be located over the second plurality of electrodes and may form a plurality of nodes that may comprise overlapping intersections of the first and second plurality of electrodes, wherein each of the plurality of nodes may comprise a mutual capacitance; providing a flexible electrically conductive cover over the first plurality of electrodes, wherein a face of the flexible electrically conductive cover may form the touch sensing surface; providing a plurality of deformable spacers between the flexible electrically conductive cover and the first plurality of electrodes, wherein the plurality of deformable spacers may maintain a distance between the flexible electrically conductive cover and the first plurality of electrodes; scanning the first plurality of electrodes for determining values of the self capacitances thereof; comparing the values of the scanned self capacitances to determine which one of the first plurality of electrodes has the largest value of self capacitance; scanning the nodes of the one of the first plurality of electrodes having the largest value of self capacitance for determining values of the mutual capacitances of the respective plurality of nodes; comparing the values of the scanned mutual capacitances of the respective plurality of nodes on the first electrode having the largest value of self capacitance, wherein the node having the largest value of mutual capacitance may be a location of a touch on the touch sensing surface; and determining a force of the touch on the touch sensing surface from a change in the values of the mutual capacitance of the node at the touch location during no touch and during the touch.

According to a further embodiment of the method, the self and mutual capacitance values may be measured with an analog front end and an analog-to-digital converter (ADC). According to a further embodiment of the method, the self and mutual capacitance values may be stored in a memory of a digital device. According to a further embodiment of the method, a digital processor in the digital device may use the stored self and mutual capacitance values in determining the touch location of the touch and the force applied by the touch to the touch sensing surface at the touch location.

According to yet another embodiment, a method for determining locations of a plurality of touches thereto and respective forces thereof on a touch sensing surface may comprise the steps of: providing a first plurality of electrodes arranged in a parallel orientation having a first axis, wherein each of the first plurality of electrodes may comprise a self capacitance; providing a second plurality of electrodes arranged in a parallel orientation having a second axis substantially perpendicular to the first axis, the first plurality of electrodes may be located over the second plurality of electrodes and may form a plurality of nodes comprising overlapping intersections of the first and second plurality of electrodes, wherein each of the plurality of nodes may comprise a mutual capacitance; providing a flexible electrically conductive cover over the first plurality of electrodes, wherein a face of the flexible electrically conductive cover may form the touch sensing surface; providing a plurality of deformable spacers between the flexible electrically conductive cover and the first plurality of electrodes, wherein the plurality of deformable spacers may maintain a distance between the flexible electrically conductive cover and the first plurality of electrodes; scanning the first plurality of electrodes for determining values of the self capacitances thereof; comparing the values of the scanned self capacitances to determine which ones of the first plurality of electrodes have the largest values of self capacitance; scanning the nodes of the ones of the first plurality of electrodes having the largest values of self capacitance for determining values of the mutual capacitances of the respective plurality of nodes; comparing the values of the scanned mutual capacitances of the respective plurality of nodes on the first electrodes having the largest values of self capacitance, wherein the nodes having the largest values of mutual capacitance may be locations of touches on the touch sensing surface; and determining a force for each of the respective touches on the touch sensing surface from a change in the values of the mutual capacitances of the nodes at the touch locations during no touch and during respective touches.

According to a further embodiment of the method, the self and mutual capacitance values may be measured with an analog front end and an analog-to-digital converter (ADC). According to a further embodiment of the method, the self and mutual capacitance values may be stored in a memory of a digital device. According to a further embodiment of the method, a digital processor in the digital device may use the stored self and mutual capacitance values in determining the touch locations of the touches and the respective forces applied by the touches to the touch sensing surface at the touch locations.

According to still another embodiment, a system for determining locations of touches thereto and respective forces thereof on a touch sensing surface may comprise: a first plurality of electrodes arranged in a parallel orientation having a first axis, wherein each of the first plurality of electrodes may comprise a self capacitance; a second plurality of electrodes arranged in a parallel orientation having a second axis substantially perpendicular to the first axis, the first plurality of electrodes may be located over the second plurality of electrodes and may form a plurality of nodes comprising overlapping intersections of the first and second plurality of electrodes, wherein each of the plurality of nodes may comprise a mutual capacitance; a flexible electrically conductive cover over the first plurality of electrodes, wherein a face of the flexible electrically conductive cover may form the touch sensing surface; a plurality of deformable spacers between the flexible electrically conductive cover and the first plurality of electrodes, wherein the plurality of deformable spacers may maintain a distance between the flexible electrically conductive cover and the first plurality of electrodes; a digital processor and memory, wherein digital outputs of the digital processor may be coupled to the first and second plurality of electrodes; an analog front end may be coupled to the first and second plurality of electrodes; an analog-to-digital converter (ADC) having at least one digital output coupled to the digital processor; wherein values of the self capacitances may be measured for each of the first plurality of electrodes by the analog front end, the values of the measured self capacitances may be stored in the memory; values of the mutual capacitances of the nodes of at least one of the first electrodes having at least one of the largest values of self capacitance may be measured by the analog front end, the values of the measured mutual capacitances may be stored in the memory; and the digital processor may use the stored self and mutual capacitance values for determining locations of the touches and the respective forces applied to the touch sensing surface.

According to a further embodiment, the digital processor, memory, analog front end and ADC may be provided by a digital device. According to a further embodiment, the digital processor, memory, analog front end and ADC may be provided by at least one digital device. According to a further embodiment, the digital device may comprise a microcontroller. According to a further embodiment, the digital device may be selected from the group consisting of a microprocessor, a digital signal processor, an application specific integrated circuit (ASIC) and a programmable logic array (PLA). According to a further embodiment, the flexible electrically conductive cover may comprise a flexible metal substrate. According to a further embodiment, the flexible electrically conductive cover may comprise a flexible non-metal substrate and an electrically conductive coating on a surface thereof. According to a further embodiment, the flexible electrically conductive cover may comprise a substantially light transmissive flexible substrate and a coating of Indium Tin Oxide (ITO) on a surface of the flexible substrate. According to a further embodiment, the flexible electrically conductive cover may comprise a substantially light transmissive flexible substrate and a coating of Antimony Tin Oxide (ATO) on a surface of the flexible substrate.

### BRIEF DESCRIPTION OF THE DRAWINGS

A more complete understanding of the present disclosure may be acquired by referring to the following description taken in conjunction with the accompanying drawings wherein:

FIG. 1 illustrates a schematic block diagram of an electronic system having a capacitive touch sensor, a capacitive touch analog front end and a digital processor, according to the teachings of this disclosure;

FIGS. 2A to 2D illustrate schematic plan views of touch sensors having various capacitive touch sensor configurations, according to the teachings of this disclosure;

FIGS. 3 and 4 illustrate schematic plan views of self and mutual capacitive touch detection of a single touch to a touch sensor, according to the teachings of this disclosure;

FIG. 5 illustrates a graph of single touch peak detection data, according to the teachings of this disclosure;

FIG. 6 illustrates schematic elevational views of metal over capacitive touch sensors, according to the teachings of this disclosure; and

FIG. 7 illustrates a schematic elevational view of a touch sensor capable of detecting both locations of touches thereto and forces of those touches, according to a specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

According to various embodiments, a touch sensing and force application surface may comprise a plurality of conductive electrode rows, a plurality of electrode columns substantially perpendicular to and over the plurality of conductive electrode rows, a flexible electrically conductive cover over the plurality of electrode columns; and a plurality of deformable spacers between the flexible electrically conductive cover and the plurality of electrode columns, wherein the plurality of deformable spacers maintains a distance between the flexible electrically conductive cover and the plurality of electrode columns. When a touch is applied to the surface of the X-Y touch sensor, the flexible electrically conductive cover is biased toward the plurality of electrode columns and rows and changes the capacitance value of a capacitor formed by an intersection of an electrode row and column proximate to the location of the touch to the X-Y touch sensor. This change in capacitance value is proportional to the force of the touch on the surface of the flexible electrically conductive cover. Therefore the location of the touch(es) may be determined by changes in the values of the self capacitances of the top electrodes and the changes in the mutual capacitances of the capacitive nodes formed by the intersections of the electrode rows and columns, and the force of the touch(es) may be determined by how much the mutual capacitance values change at the touch location(s). “Flexible” and “deformable” shall comprise the same meaning herein and will be used interchangeably.

The flexible electrically conductive cover also shields the electrode rows and columns from external capacitive influences and noise effects. Self and mutual capacitance changes are substantially dependent upon the amount of deflection (change in distance) between the electrically conductive (shield) cover over the electrode rows and columns caused by the touch(es). Furthermore the projected capacitance touch screen does not depend upon “body capacitance” so any object capable of causing deflection of the flexible electrically conductive cover will work on this touch screen, according to the teachings of this disclosure. The flexible electrically conductive cover may be grounded and/or coupled to a power supply common to further improve shielding of the conductive columns and rows.

Referring now to the drawing, the details of specific example embodiments are schematically illustrated. Like elements in the drawings will be represented by like numbers, and similar elements will be represented by like numbers with a different lower case letter suffix.

Referring to FIG. 1, depicted is a schematic block diagram of an electronic system having a capacitive touch sensor, a capacitive touch analog front end and a digital processor, according to the teachings of this disclosure. A digital device 112 may comprise a digital processor and memory 106, an analog-to-digital converter (ADC) controller 108, and a capacitive touch analog front end (AFE) 110. The digital device 112 may be coupled to a touch sensor 102 comprised of a plurality of conductive columns 104 and rows 105 arranged in a matrix and having a flexible electrically conductive cover 103 thereover. It is contemplated and within the scope of this disclosure that the conductive rows 105 and/or conductive columns 104 may be, for example but are not limited to, printed circuit board conductors, wires, Indium Tin Oxide (ITO), Antimony Tin Oxide (ATO) coatings on a clear substrate, e.g., display/touch screen, etc., or any combinations thereof. The flexible electrically conductive cover 103 may comprise metal, conductive non-metallic material, ITO or ATO coating on a flexible clear substrate (plastic), etc. The digital device 112 may comprise a microcontroller, microprocessor, digital signal processor, application specific integrated circuit (ASIC), programmable logic array (PLA), etc.; and may further comprise one or more integrated circuits (not shown), packaged or unpackaged.

Referring to FIGS. 2A to 2D, depicted are schematic plan views of touch sensors having various capacitive touch sensor configurations, according to the teachings of this disclosure. FIG. 2A shows conductive columns 104 and conductive rows 105. Each of the conductive columns 104 has a “self capacitance” that may be individually measured when in a quiescent state, or all of the conductive rows 105 may be actively excited while each one of the conductive columns 104 has self capacitance measurements made thereof. Active excitation of all of the conductive rows 105 may provide a stronger measurement signal for individual capacitive measurements of the conductive columns 104.

For example, if there is a touch detected on one of the conductive columns 104 during a self capacitance scan, then only that conductive column 104 having the touch detected thereon need be measured further during a mutual capacitance scan thereof. The self capacitance scan can only determine which one of the conductive columns 104 has been touched, but not at what location along the axis of that conductive column 104 where it was touched. The mutual capacitance scan may determine the touch location along the axis of that conductive column 104 by individually exciting (driving) one at a time the conductive rows 105 and measuring a mutual capacitance value for each one of the locations on that conductive column 104 that intersects (crosses over) the conductive rows 105. There may be an insulating non-conductive dielectric (not shown) between and separating the conductive columns 104 and the conductive rows 105. Where the conductive columns 104 intersect with (crossover) the conductive rows 105, mutual capacitors 120 are thereby formed. During the self capacitance scan above, all of the conductive rows 105 may be either grounded, e.g., V_{SS}, or driven to a voltage, e.g., V_{DD}, with a logic signal; thereby forming individual column capacitors associated with each one of the conductive columns 104.

FIGS. 2B and 2C show interleaving of diamond shaped patterns of the conductive columns 104 and the conductive rows 105. This configuration may maximize exposure of each axis conductive column and/or row to a touch (e.g., better sensitivity) with a smaller overlap between the conductive columns 104 and the conductive rows 105. FIG. 1D shows receiver (top) conductive rows (e.g., electrodes) 105a and transmitter (bottom) conductive columns 104a comprising comb like meshing fingers. The conductive columns 104a and conductive rows 105a are shown in a side-by-side plan view, but normally the top conductive rows 105a would be over the bottom conductive columns 104a. Projected capacitive touch technology comprising self and mutual capacitive touch detection is more fully described in Technical Bulletin TB3064, entitled “mTouch™ Projected Capacitive Touch Screen Sensing Theory of Operation” by Todd O'Connor, available at www.microchip.com; and commonly owned United States Patent Application Publication No. US 2012/0113047, entitled “Capacitive Touch System Using Both Self and Mutual Capacitance” by Jerry Hanauer; wherein both are hereby incorporated by reference herein for all purposes.

Referring to FIGS. 3 and 4, depicted are schematic plan views of self and mutual capacitive touch detection of a single touch to a touch sensor, according to the teachings of this disclosure. In FIG. 3 a touch, represented by a picture of a part of a finger, is at approximately the coordinates of X05, Y07. During self capacitive touch detection each one of the rows Y01 to Y09 may be measured to determine the capacitance values thereof. Note that baseline capacitance values with no touches thereto for each one of the rows Y01 to Y09 have been taken and stored in a memory (e.g., memory 106—FIG. 1). Any significant capacitance change to the baseline capacitance values of the rows Y01 to Y09 will be obvious and taken as a finger touch. In the example shown in FIG. 3 the finger is touching row Y07 and the capacitance value of that row will change, indicating a touch thereto. However it is still unknown from the self capacitance measurements where on this row that the touch has occurred.

Once the touched row (Y07) has been determined using the self capacitance change thereof, mutual capacitive detection may be used in determining where on the touched row (Y07) the touch has occurred. This may be accomplished by exciting, e.g., putting a voltage pulse on, each of the columns X01 to X12 one at a time while measuring the capacitance value of row Y07 when each of the columns X01 to X12 is individually excited. The column (X05) excitation that causes the largest change in the capacitance value of row Y07 will be the location on that row which corresponds to the intersection of column X05 with row Y07, thus the single touch is at point or node X05, Y07. Using self and mutual capacitance touch detection significantly reduces the number of row and column scans to obtain the X,Y touch coordinate on the touch sensor 102. In this example, nine (9) rows were scanned during self capacitive touch detection and twelve (12) columns were scanned during mutual capacitive touch detection for a total number of 9+12=21 scans. If individual x-y capacitive touch sensors for each node (location) were used then 9×12=108 scans would be necessary to find this one touch, a significant difference. It is contemplated and within the scope of this disclosure that the self capacitances of the columns X01 to X21 may be determined first then mutual capacitances determined of a selected column(s) by exciting each row Y01 to Y09 to find the touch location on the selected column(s).

Referring to FIG. 5, depicted is a graph of single touch peak detection data, according to the teachings of this disclosure. An example graph of data values for one column (e.g., column 7) of the touch sensor 102 is shown wherein a maximum data value determined from the self and mutual capacitance measurements of column 7 occurs at the capacitive touch sensor 104 area located a row 7, column 7. All data values that are below a threshold value may be ignored, e.g., below about 12 in the graphical representation shown in FIG. 5. Therefore only data values taken at row 6 (data value=30) and at row 7 (data value=40) need be processed in determining the location of a touch to the touch sensor 102. Slope may be determined by subtracting a sequence of adjacent row data values in a column to produce either a positive or negative slope value. When the slope value is positive the data values are increasing, and when the slope value is negative the data values are decreasing A true peak may be identified as a transition from a positive to a negative slope as a potential peak. A transition from a positive slope to a negative slope is indicated at data value 422 of the graph shown in FIG. 3. The data values may be normalized capacitance values that may be determined as more fully described in commonly owned U.S. patent application Ser. No. 13/830,891, filed Mar. 14, 2013; entitled “Method And System For Multi-Touch Decoding,” by Lance Lamont and Jerry Hanauer; which is hereby incorporated by reference herein for all purposes. Non-normalized (e.g., absolute capacitance values) and/or normalized capacitance values may be used in determining the “force” (e.g., proportional to magnitude of capacitance value change) of the touch(es) applied to the face of the touch sensor 102.

Referring to FIG. 6, depicted are schematic elevational views of metal over capacitive touch sensors, according to the teachings of this disclosure. A capacitive sensor 338 is on a substrate 332. On either side of the capacitive sensor 338 are spacers 334, and an electrically conductive flexible cover 103, e.g., metal, ITO or ATO coated plastic, etc.; is located on top of the spacers 334 and forms a chamber 336 over the capacitive sensor 338. When a force 342 is applied to a location on the flexible cover 103, the flexible cover 103 moves toward the capacitive sensor 338, thereby increasing the capacitance thereof. The capacitance value(s) of the capacitive sensor(s) 338 is measured and an increase in capacitance value thereof will indicate the location of the force 342 (e.g., touch). The capacitance value of the capacitive sensor 338 will increase the closer the flexible cover 103 moves toward the face of the capacitive sensor 338. Metal over capacitive touch technology is more fully described in Application Note AN1325, entitled “mTouch™ Metal over Cap Technology” by Keith Curtis and Dieter Peter, available www.microchip.com; and is hereby incorporated by reference herein for all purposes.

Referring to FIG. 7, depicted is a schematic elevational view of a touch sensor capable of detecting both locations of touches thereto and forces of those touches, according to a specific example embodiment of this disclosure. A touch sensor capable of detecting both a location of a touch(es) thereto and a force(s) of that touch(es) thereto, generally represented by the numeral 102, may comprise a plurality of conductive rows 105, a plurality of conductive columns 104, a plurality of deformable spacers 434, and a flexible electrically conductive cover 103.

The conductive columns 104 and the conductive rows 105 may be used in determining a location(s) of a touch(es), more fully described in Technical Bulletin TB3064, entitled “mTouch™ Projected Capacitive Touch Screen Sensing Theory of Operation” referenced hereinabove, and the magnitude of changes in the capacitance values of the conductive column(s) 104 at and around the touch location(s) may be used in determining the force 342 (amount of pressure applied at the touch location). The plurality of deformable spacers 434 may be used to maintain a constant spacing between the flexible conductive cover 103 and a front surface of the conductive columns 104 when no force 342 is being applied to the flexible electrically conductive cover 103. When force 342 is applied to a location on the flexible electrically conductive cover 103, the flexible electrically conductive cover 103 will be biased toward at least one conductive column 104, thereby increasing the capacitance thereof. Direct measurements of capacitance values and/or ratios of the capacitance values may be used in determining the magnitude of the force 342 being applied at the touch location(s).

Referring back to FIG. 1, microcontrollers 112 now include peripherals that enhance the detection and evaluation of such capacitive value changes. Detailed descriptions of various capacitive touch system applications are more fully disclosed in Microchip Technology Incorporated application notes AN1298, AN1325 and AN1334, available at www.microchip.com, and all are hereby incorporated by reference herein for all purposes. One such application utilizes the capacitive voltage divider (CVD) method to determine a capacitance value and/or evaluate whether the capacitive value has changed. The CVD method is more fully described in Application Note AN1208, available at www.microchip.com; and a more detailed explanation of the CVD method is presented in commonly owned United States Patent Application Publication No. US 2010/0181180, entitled “Capacitive Touch Sensing using an Internal Capacitor of an Analog-To-Digital Converter (ADC) and a Voltage Reference,” by Dieter Peter; wherein both are hereby incorporated by reference herein for all purposes.

A Charge Time Measurement Unit (CTMU) may be used for very accurate capacitance measurements. The CTMU is more fully described in Microchip application notes AN1250 and AN1375, available at www.microchip.com, and commonly owned U.S. Pat. No. 7,460,441 B2, entitled “Measuring a long time period;” and U.S. Pat. No. 7,764,213 B2, entitled “Current-time digital-to-analog converter,” both by James E. Bartling; wherein all of which are hereby incorporated by reference herein for all purposes.

It is contemplated and within the scope of this disclosure that any type of capacitance measurement circuit having the necessary resolution may be used in determining the capacitance values of the plurality of conductive columns 104 and/or rows 105, and that a person having ordinary skill in the art of electronics and having the benefit of this disclosure could implement such a capacitance measurement circuit.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An apparatus for determining a location of a touch thereto and a force thereof on a touch sensing surface, comprising:
a first plurality of electrodes arranged in a parallel orientation having a first axis, wherein each of the first plurality of electrodes comprises a self capacitance;
a second plurality of electrodes arranged in a parallel orientation having a second axis substantially perpendicular to the first axis, the first plurality of electrodes are located over the second plurality of electrodes and form a plurality of nodes comprising overlapping intersections of the first and second plurality of electrodes, wherein each of the plurality of nodes comprises a mutual capacitance;
a flexible electrically conductive cover over the first plurality of electrodes, wherein a face of the flexible electrically conductive cover forms the touch sensing surface; and
a plurality of deformable spacers between the flexible electrically conductive cover and the first plurality of electrodes, wherein the plurality of deformable spacers maintains a distance between the flexible electrically conductive cover and the first plurality of electrodes.

2. The apparatus according to claim 1, wherein the flexible electrically conductive cover comprises a flexible metal substrate.

3. The apparatus according to claim 1, wherein the flexible electrically conductive cover comprises a flexible non-metal substrate and an electrically conductive coating on a surface thereof.

4. The apparatus according to claim 1, wherein the flexible electrically conductive cover comprises a substantially light transmissive flexible substrate and a coating of Indium Tin Oxide (ITO) on a surface of the flexible substrate.

5. The apparatus according to claim 1, wherein the flexible electrically conductive cover comprises a substantially light transmissive flexible substrate and a coating of Antimony Tin Oxide (ATO) on a surface of the flexible substrate.

6. A method for determining a location of a touch thereto and a force thereof on a touch sensing surface, said method comprising the steps of:
providing a first plurality of electrodes arranged in a parallel orientation having a first axis, wherein each of the first plurality of electrodes comprises a self capacitance;
providing a second plurality of electrodes arranged in a parallel orientation having a second axis substantially perpendicular to the first axis, the first plurality of electrodes are located over the second plurality of electrodes and form a plurality of nodes comprising overlapping intersections of the first and second plurality of electrodes, wherein each of the plurality of nodes comprises a mutual capacitance;
providing a flexible electrically conductive cover over the first plurality of electrodes, wherein a face of the flexible electrically conductive cover forms the touch sensing surface;
providing a plurality of deformable spacers between the flexible electrically conductive cover and the first plurality of electrodes, wherein the plurality of deformable spacers maintains a distance between the flexible electrically conductive cover and the first plurality of electrodes;
scanning the first plurality of electrodes for determining values of the self capacitances thereof;
comparing the values of the scanned self capacitances to determine which one of the first plurality of electrodes has the largest value of self capacitance;
scanning the nodes of the one of the first plurality of electrodes having the largest value of self capacitance for determining values of the mutual capacitances of the respective plurality of nodes;
comparing the values of the scanned mutual capacitances of the respective plurality of nodes on the first electrode having the largest value of self capacitance, wherein the node having the largest value of mutual capacitance is a location of a touch on the touch sensing surface; and
determining a force of the touch on the touch sensing surface from a change in the values of the mutual capacitance of the node at the touch location during no touch and during the touch.

7. The method as recited in claim 6, wherein the self and mutual capacitance values are measured with an analog front end and an analog-to-digital converter (ADC).

8. The method as recited in claim 7, wherein the self and mutual capacitance values are stored in a memory of a digital device.

9. The method as recited in claim 8, wherein a digital processor in the digital device uses the stored self and mutual capacitance values in determining the touch location of the touch and the force applied by the touch to the touch sensing surface at the touch location.

10. A method for determining locations of a plurality of touches thereto and respective forces thereof on a touch sensing surface, said method comprising the steps of:
providing a first plurality of electrodes arranged in a parallel orientation having a first axis, wherein each of the first plurality of electrodes comprises a self capacitance;
providing a second plurality of electrodes arranged in a parallel orientation having a second axis substantially perpendicular to the first axis, the first plurality of electrodes are located over the second plurality of electrodes and form a plurality of nodes comprising overlapping intersections of the first and second plurality of electrodes, wherein each of the plurality of nodes comprises a mutual capacitance;
providing a flexible electrically conductive cover over the first plurality of electrodes, wherein a face of the flexible electrically conductive cover forms the touch sensing surface;
providing a plurality of deformable spacers between the flexible electrically conductive cover and the first plurality of electrodes, wherein the plurality of deformable spacers maintains a distance between the flexible electrically conductive cover and the first plurality of electrodes;
scanning the first plurality of electrodes for determining values of the self capacitances thereof;
comparing the values of the scanned self capacitances to determine which ones of the first plurality of electrodes have the largest values of self capacitance;
scanning the nodes of the ones of the first plurality of electrodes having the largest values of self capacitance for determining values of the mutual capacitances of the respective plurality of nodes;
comparing the values of the scanned mutual capacitances of the respective plurality of nodes on the first electrodes having the largest values of self capacitance, wherein the nodes having the largest values of mutual capacitance are locations of touches on the touch sensing surface; and
determining a force for each of the respective touches on the touch sensing surface from a change in the values of the mutual capacitances of the nodes at the touch locations during no touch and during respective touches.

11. The method as recited in claim 10, wherein the self and mutual capacitance values are measured with an analog front end and an analog-to-digital converter (ADC).

12. The method as recited in claim 11, wherein the self and mutual capacitance values are stored in a memory of a digital device.

13. The method as recited in claim 12, wherein a digital processor in the digital device uses the stored self and mutual capacitance values in determining the touch locations of the touches and the respective forces applied by the touches to the touch sensing surface at the touch locations.

14. A system for determining locations of touches thereto and respective forces thereof on a touch sensing surface, said system comprising:
a first plurality of electrodes arranged in a parallel orientation having a first axis, wherein each of the first plurality of electrodes comprises a self capacitance;
a second plurality of electrodes arranged in a parallel orientation having a second axis substantially perpendicular to the first axis, the first plurality of electrodes are located over the second plurality of electrodes and form a plurality of nodes comprising overlapping intersections of the first and second plurality of electrodes, wherein each of the plurality of nodes comprises a mutual capacitance;
a flexible electrically conductive cover over the first plurality of electrodes, wherein a face of the flexible electrically conductive cover forms the touch sensing surface;
a plurality of deformable spacers between the flexible electrically conductive cover and the first plurality of electrodes, wherein the plurality of deformable spacers maintains a distance between the flexible electrically conductive cover and the first plurality of electrodes;
a digital processor and memory, wherein digital outputs of the digital processor are coupled to the first and second plurality of electrodes;
an analog front end coupled to the first and second plurality of electrodes;
an analog-to-digital converter (ADC) having at least one digital output coupled to the digital processor;
wherein
values of the self capacitances are measured for each of the first plurality of electrodes by the analog front end,
the values of the measured self capacitances are stored in the memory;
values of the mutual capacitances of the nodes of at least one of the first electrodes having at least one of the largest values of self capacitance are measured by the analog front end,
the values of the measured mutual capacitances are stored in the memory; and
the digital processor uses the stored self and mutual capacitance values for determining locations of the touches and the respective forces applied to the touch sensing surface.

15. The system as recited in claim 14, wherein the digital processor, memory, analog front end and ADC are provided by a digital device.

16. The system as recited in claim 14, wherein the digital processor, memory, analog front end and ADC are provided by at least one digital device.

17. The system as recited in claim 1S2, wherein the digital device comprises a microcontroller.

18. The system as recited in claim 1S2, wherein the digital device is selected from the group consisting of a microprocessor, a digital signal processor, an application specific integrated circuit (ASIC) and a programmable logic array (PLA).

19. The system as recited in claim 14, wherein the flexible electrically conductive cover comprises a flexible metal substrate.

20. The system as recited in claim 14, wherein the flexible electrically conductive cover comprises a flexible non-metal substrate and an electrically conductive coating on a surface thereof.

21. The system as recited in claim 14, wherein the flexible electrically conductive cover comprises a substantially light transmissive flexible substrate and a coating of Indium Tin Oxide (ITO) on a surface of the flexible substrate.

22. The system as recited in claim 14, wherein the flexible electrically conductive cover comprises a substantially light transmissive flexible substrate and a coating of Antimony Tin Oxide (ATO) on a surface of the flexible substrate.
